(19) United States
(12) Patent Application Publication
(10) Pub. No.: US 2005/0066022 A1
(43) Pub. Date: Mar. 24, 2005

(54) Quiet resume on LAN

(76) Inventor: Frank Liebenow, Jefferson, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/770,961

(22) Filed: Feb. 3, 2004

Related U.S. Application Data
(60) Provisional application No. 60/500,628, filed on Sep. 5, 2003.

(51) Int. Cl. G06F 15/173

(52) U.S. Cl. 709/223

(57) ABSTRACT

A special Wake-on-LAN packet is provided, operationally enabled within a computer readable medium, which establishes a computer into a pre-determined operating environment within a networked computing environment. A system is provided for executing the special Wake-on-LAN packet and establishing the pre-determined operating environment.

This application is related to, and claims priority to U.S. provisional application No. 60/500,628, filed Sep. 5, 2003, entitled “QUIET RESUME ON LAN”, Attorney Docket Number P1961US00, the entirety of which is incorporated by reference herein, including all of the documents referenced therein.

### FIELD OF THE INVENTION

The present invention generally relates to the field of network computing, and particularly to execution of a pre-determined operating environment within computers coupled to a LAN.

### BACKGROUND OF THE INVENTION

Network computing involves the communicative coupling of a plurality of computing systems. An example of this is an LAN (Local Area Network) which establishes an environment wherein Data Terminal Equipment (DTE) devices, such as computers and peripheral devices, are connected to the network or communicatively coupled together through a communication medium which allows for the exchange of information between the separate DTE's of the LAN. Typically, a LAN is a minimum area network covering a relatively small environment. The communication medium employed may establish a hard-wired connection between the separate DTE's or wireless technology may be employed (i.e., infrared, RF, Bluetooth) to establish the various connections.

Currently, two basic types of LAN's exist: peer-to-peer and client-server. In peer-to-peer, all DTE's are equal and share information and resources. In client-server LAN's, one machine acts as a dedicated server providing information and services upon request from other LAN users. In each type of LAN, a WOL (Wake-on-LAN) function may be employed to remotely activate DTE's when needed.

In grid computing environments, the resources of many computers in a network, such as a LAN, are applied to a single problem at the same time—usually to a scientific or technical problem that requires a great number of computer processing cycles or access to large amounts of data. Typically, within a grid computing environment, a managing computer employs software which may divide and assign pieces of a program to as many as several thousand computers. Thought of as distributed and large-scale cluster computing and as a form of network-distributed parallel processing, grid computing may be confined to a network of computer workstations within a corporation (e.g., LAN) or it may be a public collaboration, which does not employ the typical architecture of a managing computer and slave computers (in which case it is also sometimes known as a form of peer-to-peer computing.)

Current Resume on LAN technology or WOL technology allows a controlling computer to send a “Wake” packet to a slave computer over the LAN. This packet will cause the suspended slave computer to return to its normal operating state, along with all the previous applications that were running, also turning on the display device. This restores the system of the slave computer to a full operating state, possibly for remote administration and diagnostics. In this state, all user applications are restored as well as all hardware devices. However, in a grid environment, there may be no need to return slave computers back to a normal operating state in which all hardware subsystems, such as optical drives, floppy disks, modems, and/or monitors, are initialized and powered.

Therefore, it would be desirable to provide a special WOL packet for providing a pre-determined operating environment to a computer within a networked computing environment.

### SUMMARY OF THE INVENTION

Accordingly, the present invention provides a quiet Resume-on-LAN capability, enabled through a special Wake-on-LAN packet which directs how a slave computer, in a networked environment, wakes. It is an object of the present invention to facilitate networked computing, particularly grid computing. The special Wake-on-LAN packet provided by the present invention provides for awakening a computer into a pre-determined operating environment which may not require the initialization and/or powering of all hardware subsystems. This selective initialization reduces system requirements and promotes efficiency. Further, the present invention does not restore the computer's suspended state. The pre-determined operating state facilitates the operation of tasks or storage needed by the network through limited functionality of the computer.

In a first aspect of the present invention, a method of operating a computer in a networked computing environment includes communicating a wake up state to the computer and awakening the computer to the wake up state. The wake up state is one of a plurality of states in which the computer is configured to operate and enables the operation of a task or storage by the computer. In a second aspect of the present invention, a method of operating a computer in a networked computing environment comprises placing the computer in a sleep state, communicating a wake up state to the computer, and awakening the computer to the wake up state. The wake up state is one of a plurality of states in which the computer is configured to operate and enables the operation of a task or storage by the computer.

In a third aspect of the present invention, a signal tangibly embodying a set of computer readable instructions comprises a first command communicating a wake up state from a managing computer to a slave computer. A second command communicates a function to be executed by the slave computer during a wake period and a third command returns the slave computer to a sleep state upon completion of the function. The signal loads a pre-determined operating system into the slave computer for performance of the function.

In a fourth aspect of the present invention, a method for performing a task on a slave computer, the slave computer being in sleep state in a networked computing environment includes communicating a wake up state from a managing computer to the slave computer. The slave computer is awakened into a wake up state which is one of a plurality of states configured for operation of the slave computer. The slave computer then executes a function transmitted by the managing computer and returns to the sleep state after completing the function. This function may accomplish a single task or provide a remote administrator remote access to the computer. This may allow the remote administrator the ability to perform maintenance and upgrade functions without providing power to the monitor and other hardware subsystems.

In a fifth aspect of the present invention, an apparatus for connecting a computer to a network and providing a signal to the computer for instructing the computer to load a pre-determined operating environment onto the computer is provided. The apparatus includes a communication assembly communicatively coupling the apparatus with the network, the communication assembly for receiving a special Wake-on-LAN (WOL) packet specifying a wake up state to the computer from an initiator communicatively coupled to the network. Additionally, an integrated device assembly is coupled with the receiver assembly, the integrated device assembly for supporting the receipt and transmission of the wake up state to the computer. The apparatus further includes an interface assembly coupled with the integrated device assembly, the interface assembly for providing a communicative coupling between the integrated device assembly and the computer and a local bus assembly coupled with the integrated device assembly, the local bus providing the interface between the interface assembly and the integrated device and between the integrated device assembly and a remote circuit assembly. The apparatus awakens the computer to the wake up state, the wake up state being one of a plurality of states in which the computer is configured to operate.

In a sixth aspect of the present invention, a computer communicatively coupled with a second computer, the computer for transmitting a pre-determined operating environment over a network to the second computer is provided. The computer includes an executable stored in a memory of the computer, the executable for providing a wake up state configuration for the second computer, and a communication assembly operationally coupled with the memory, the communication assembly communicatively coupling the computer with the network for transmitting the executable. The second computer is awakened into the wake up state, the wake up state being one of a plurality of states in which the second computer is configured to operate.

In a seventh aspect of the present invention, a computer system, which may be configured into a pre-determined operating environment by receiving a signal over a network from a remote computer, is provided. The computer system includes a communication assembly for receiving the signal, which provides a wake up state, transmitted over the network, the communication assembly being operative even when the computer system is in a sleep mode. The computer system further comprising a processor coupled with the communication assembly, the processor for executing the wake up state upon the computer system. The wake up state instructs the processor to awaken the computer system into one of a plurality of operational states configurable on the computer system.

In an eighth aspect of the present invention, a computer network, the network establishing communicative links amongst computers via a communication framework assembly, is provided. The network includes a first computer including a first communication adapter which communicatively couples the first computer with the communication framework assembly of the network, the first computer further comprising an executable stored in a memory which is coupled with a processor and the first communication adapter, the executable being transmitted over the network and providing a wake up state. The network further includes a second computer including a second communication adapter which communicatively couples the second computer with the communication framework assembly of the network, the second communication adapter for receiving the wake up state provided by the executable transmitted over the network. The executable transmitted over the network awakens the second computer to the wake up state, the wake up state being one of a plurality of states in which the second computer is configured to operate.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart illustrating a first exemplary method performed by the present invention for operating a personal computing system within a networked computing environment;

FIG. 2 is a flowchart illustrating a second exemplary method performed by the present invention for operating the personal computing system of the networked computing environment;

FIG. 3 is a flowchart illustrating a method of performing a task via the personal computing system of the network;

FIG. 4 is a flowchart illustrating a method of executing an application over a computing network, such as a grid computing network;

FIG. 5 is an illustration of a block diagram representing an exemplary configuration of the hardware arrangement of a computing system, the computing system capable of being employed in LAN and grid network environments;

FIG. 6 is a block diagram illustrating specific components of the computing system of FIG. 5 in accordance with an exemplary embodiment of the present invention; and

FIGS. 7A, 7B, 7C, and 7D illustrate various exemplary network implementations which may employ the methodologies of the present invention, as shown and described in FIGS. 1 through 4, and apparatus of the present invention, as shown and described in FIGS. 5 and 6.

### DETAILED DESCRIPTION OF THE INVENTION

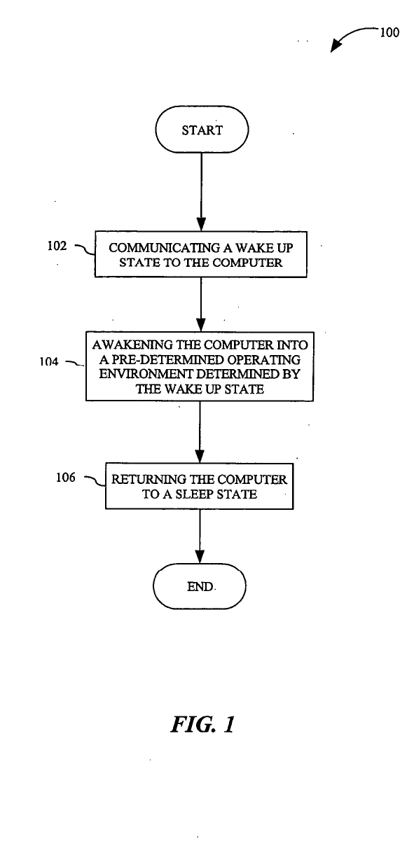

Reference will now be made in detail to the presently preferred embodiments of the invention, examples of which are illustrated in the accompanying FIGS. 1 through 7.

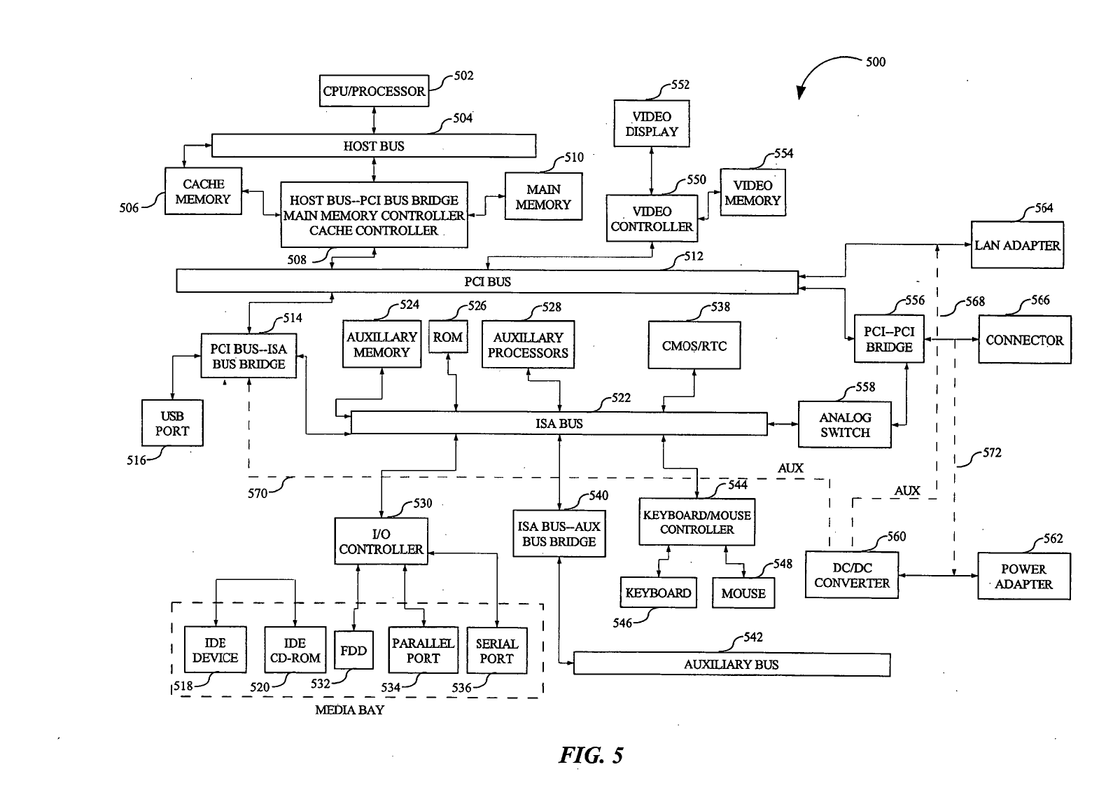

Referring now to FIG. 1, a flowchart 100 illustrating the functional steps performed by a signal tangibly embodying a computer readable medium of the present invention, is described. It is understood that the signal may be implemented as a software application which may be a stand alone application or an application integrated within other software. In preferred embodiments, the signal is executed in a networked computing environment where a plurality of computers is communicatively coupled together in a g rid network. Alternatively, the networked computing environment may comprise a variety of networks, such as local area network (LAN), wide area network (WAN), internet, intranet, and the like. In the grid network an initiator, a computer system which acts as the manager of the other communicatively linked computer systems, may send the signal of the present invention to the other computers, often referred to as slave computers. An exemplary computer system is described below in FIG. 5 and may be implemented as the initiator and/or slave computers. It is understood that when a slave computer is not being used it is often the case that it is operating in a “sleep” mode. This sleep mode is a reduced operational mode requiring less processing power to maintain. It is seen that the slave computer is '7awakened” by the initiator when the slave is required to perform a function.

The signal, in step 102, communicates a wake up state from the initiator to the slave computer. Similar in technology to a Wake-on-LAN packet, the signal of the present invention comprises a special Wake-on-LAN packet and directs how the slave computer is brought to operational (awake) status. In the current embodiment, the signal is sent to a LAN card operative within the slave computer. The LAN card is a communication assembly operationally coupled, through a LAN adapter 564 described in FIG. 5 below, with the processor of the slave computer and, in step 104, the signal starts the boot cycle or ‘awakens’ the slave computer. In effect the signal instructs the computer's BIOS to check the LAN card's status before loading any operating system or before initializing any other hardware. If a particular status bit is set, the BIOS initializes only the hardware required to load and run a particular task. Thus, the slave computer may not be fully restored. Rather, the signal of the present invention may load a pre-determined operating environment to facilitate the operation of tasks or storage needed by the networked (grid) system. For example, the BIOS may not initialize and/or power hardware subsystems that are not needed such as optical drives, floppy drives, and monitors, leaving them in a low-power or off state.

Preferably, the signal sets a status bit for the performance of a task, such as loading an operating system that may establish communications with the initiator of the signal containing the special Wake-on-LAN packet. This operating system may then start applications that communicate with the initiator to accept new tasks, transfer files, and the like. It is contemplated that the signal sent from the initiator may include a further command 106 whereby the slave computer returns to a sleep state after the completion of the task or storage function performed within the pre-determined operating environment.

The networked (grid) computing environment of the present invention may be established using a variety of technologies. For example, Ethernet communication connections may be established in a local area network (LAN) for the transfer of information between multiple computers. The plurality of computers may be hardwired together or, alternatively, the computers may be networked through wireless connections. The wireless technology employed may take a variety of forms, such as infrared, radio frequency, Bluetooth, and the like, as may be contemplated by one of ordinary skill in the art.

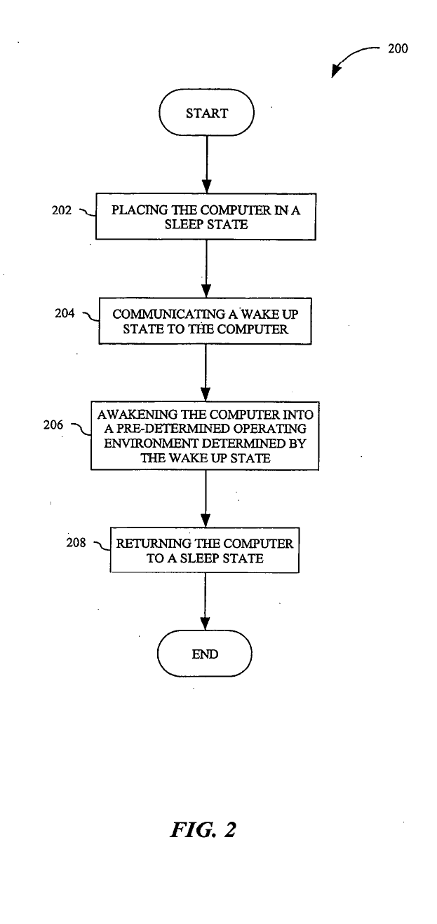

In a second exemplary embodiment shown in FIG. 2, a flowchart 200 illustrates functional steps performed by a signal tangibly embodying a computer readable medium of the present invention, an initiator using the signal of the present invention, in step 202, places the slave computer in a sleep or low power or off state. The initiator then ‘awakens’ the slave computer, in step 204, by communicating a wake up state to the slave computer. The communication is carried out through a communication assembly linking the slave with the initiator. The LAN card described above is an exemplary communication assembly and provides for the receiving of the signal by the slave from the initiator. The wake up state places the slave into a pre-determined operating environment 206, similar to that discussed in FIG. 1. This pre-determined operating environment 206 allows the slave to perform tasks or provide storage as specified by the requirements of the pre-determined operating environment. The slave computer performs the commanded task or storage and then, in step 208, the slave computer returns to the sleep state.

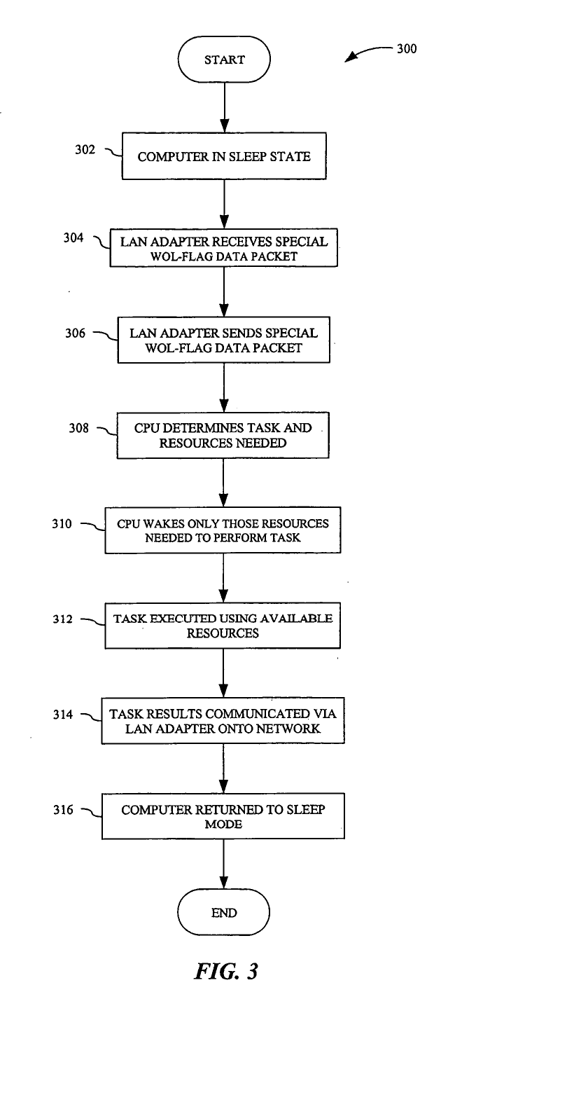

Referring now to FIG. 3, a method 300 for performing a function by a computer in a networked environment, is described. The computer is established in a sleep, low power, or off state in step 302. In the preferred embodiment, the computer utilizes a LAN card operationally coupled through a LAN adapter with the CPU of the computer. The LAN adapter receives the special Wake-on-LAN packet contained in the signal of the present invention in step 304. The LAN adapter sends the special Wake-on-LAN packet to the CPU of the computer system in step 306. From the special Wake-on-LAN packet received, the computer identifies the function being requested and determines the resources needed to execute the function in step 308. The computer next identifies and ‘wakes’ only those hardware resources needed to perform the function in step 310. Thus, the computer has established the pre-determined operating environment directed by the special Wake-on-LAN packet contained in the signal of the present invention. The function is executed using the available hardware resources in step 312. The results of the function are communicated, via the LAN adapter through the LAN card, back into the network in step 314. There the results may be retrieved by another computer, such as the initiator. Upon completion and communication of the results of the function, the computer is returned to the sleep mode to preserve processing power in step 316. It is to be noted that the computer is returned to its prior state, the state prior to receiving the special Wake-on-LAN packet. Therefore, if the computer was in a suspend or hibernate mode and an operating system and several applications were active before it had entered that mode, a normal resume function restores the computer to its previous operating environment and that operating system and those applications restore to their prior operating state.

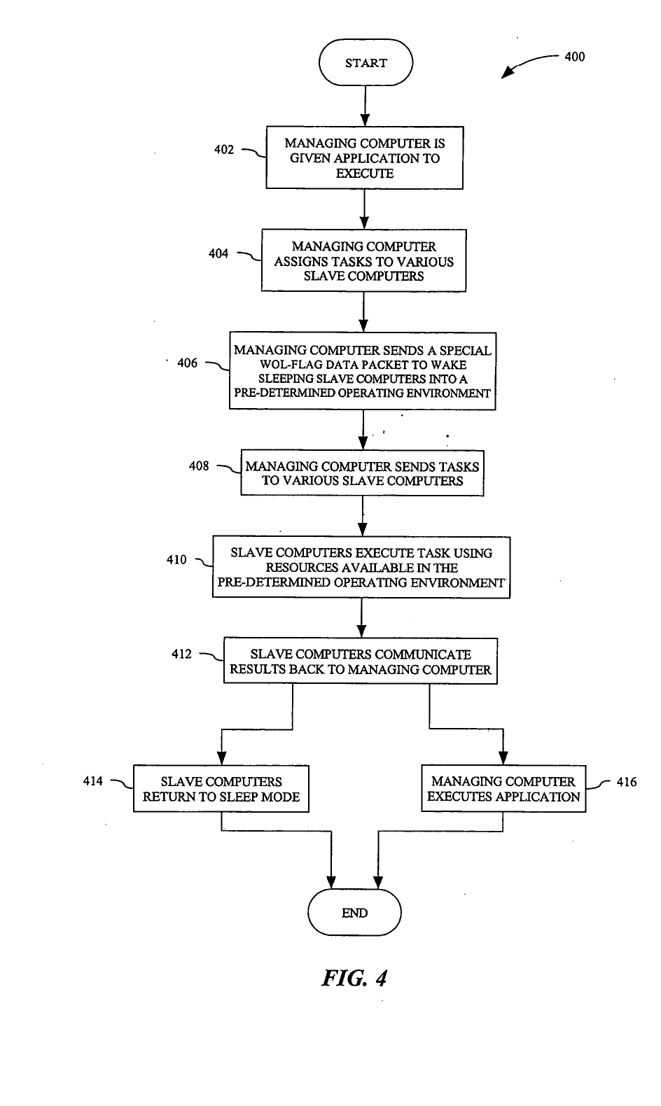

In FIG. 4 a method 400 for performing a function within a grid network computing environment, is described. In step 402 the managing (initiator) computer is given an application to execute. The application may be received by the managing computer in a standard manner, such as a download from a computer readable medium like a floppy disk, CD-ROM, and the like. The managing computer, in step 404, identifies the tasks to be performed by the application and assigns these tasks to various slave computers communicatively linked with it. The managing computer then sends a special Wake-on-LAN packet to ‘awaken’ the sleeping slave computers into a plurality of pre-determined operating environments in step 406. For example, any number of computers may be awakened into unique operating environments to solve a problem an additional computer may be awakened to operate a printer for the printing out of the results. The plurality of pre-determined operating environments is set by the managing computer based on the required processing capabilities for the execution of the task assigned to the slave computer. After awakening the slave computers into their pre-determined operating environments the managing computer, in step 408, sends the assigned tasks to the appropriate slave computers. The slave computers, in step 410, execute the tasks assigned using the resources made available by the pre-determined operating environment. Upon completion of the tasks the slave computers communicate the results back to the managing computer in step 412. After the slave computers communicate the results, the special Wake-on-LAN packet returns them to their sleep modes in step 414. Additionally, the managing computer in step 416, using the results obtained from the slave computers, executes or completes the application.

The present invention may be implemented as programs of instructions resident in the memory of one or more computer systems or servers configured generally as described in FIG. 3. Until required by the computer system or server, the set of instructions may be stored in another readable memory device, for example, in a hard disk drive or in a removable memory such as an optical disk for utilization in a CD-ROM drive or a DVD drive, a floppy disk for utilization in a floppy disk drive, a personal computer memory card for utilization in a personal computer card slot, or the like. Further, the program of instructions may be stored in the memory of another computer system or server and transmitted over a local area network or a wide area network, such as the Internet, an intranet, or the like, when desired by the user. Additionally, the instructions may be transmitted over a network in the form of an applet that is interpreted or compiled after transmission to the computer system or server rather than prior to transmission. One skilled in the art appreciates that the physical storage of the sets of instructions or applets physically changes the medium upon which it is stored electrically, magnetically, chemically, physically, optically or holographically so that the medium carries computer readable information.

Referring now to FIG. 5, an exemplary hardware system 500 generally representative of an information handling system, such as a computer, sold or leased to host customers in accordance with the present invention is shown. For example, the computer may be a desktop personal computer (PC), a notebook PC, and the like. The hardware system 500 is controlled by a central processing system 502 (CPU). The central processing system 502 includes a central processing unit such as a microprocessor or microcontroller for executing programs, performing data manipulations and controlling the tasks of the hardware system 500. Communication with the central processor 502, by hardware components described later, is implemented through a high speed host bus 504. It is contemplated that the bus 504 may include a data channel for facilitating information transfer between storage and other peripheral components of the hardware system. The bus 504 may further provide the set of signals required for communication with the central processing system 502 including a data bus, address bus, and control bus.

In the preferred embodiment, the high speed host bus 504 connects with these hardware components through its pins, such as a PCI bus 512, an ISA bus 522, and an auxiliary bus 542. These buses provide for the transferring of information among the components of the hardware system 500.

In the current embodiment, a Host bus-PCI bus (HPCI) bridge circuit 508 enables communication between the host bus 504 and the PCI bus 512. In the current embodiment, the HPCI 508 includes a main memory controller and a cache controller. The main memory controller allows the HPCI 508 to control an operation for accessing main memory 510. This is accomplished by enabling the main memory controller with logic for mapping addresses to and from the CPU 502 to particular areas of the main memory 510. It is known that data transfer speeds differ between buses. Thus, the HPCI 508 further acts as a buffer to absorb any data transfer speed differences between the host bus 504 and the PCI bus 512.

The main memory 510 is a volatile random access memory (RAM) composed of a plurality of memory modules, typically DRAM (Dynamic RAM) chips. Other semi-conductor-based memory types which may be employed with the hardware system 500 may include, for example, synchronous dynamic random access memory (SDRAM), Rambus dynamic random access memory (RDRAM), ferroelectric random access memory (FRAM), and so on. The main memory 510 provides storage of instructions and data for programs executing on the central processing system 502. The programs to be executed by the CPU 502 include device drivers that access an operating system (OS), or the like and peripheral devices, application programs for specified jobs, and firmware stored in a ROM 526 (described later). The memory capacity of the RAM may vary greatly, for example, ranging from 12 MB, to 64 MB, to 256 MB, to 512 MB. It is understood that the specific configuration of the main memory 510 may vary as contemplated by one of ordinary skill in the art.

A cache memory 506 is connected to the host bus 504 and the HPCI bridge 508. Cache memory is high-speed memory for temporary storage of limited amounts of code and data that the CPU 502 frequently accesses. The cache 506 operates to absorb the time required by the CPU 502 to access the main memory. In a preferred embodiment, the cache 506 may be implemented as an L-2 cache consisting of SRAM (Static RAM) chips, or the like with memory capacity as contemplated by one of ordinary skill in the art.

The buses 504, 512, 522, and 542, may comprise any state of the art bus architecture according to promulgated standards, for example, industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

In the preferred embodiment, the PCI bus 512 provides a relatively fast data transfer rate and directly communicates with devices such as the video controller 550. The video controller 550 couples with the video memory 554 and a video display 552. Graphic commands or the like are received from the CPU 502 by the video controller 550. The commands are processed and then temporarily stored in the video memory 554 before being output as graphics upon the video display 552. Common to video controllers is a digital to analog converter which converts a video signal to an analog signal. The analog signal may be output through CRT ports or other communication assemblies, such as LAN docking connectors, and the like. Video memory 554 may be, for example, video random access memory (VRAM), synchronous graphics random access memory (SGRAM), windows random access memory (WRAM), and the like. The video display 552 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth.

Other devices such as card bus controllers and the like are also typically in direct communicative contact with the PCI bus. PCI card slots are commonly found on many computers being formed in the wall or face of the computer. PC cards which conform to certain industry standards, such as those determined by the PCMCIA or JEIDA, may be used within these slots. Card bus controllers directly transmit PCI bus signals to the interface connector of a PCI card slot.

In situations where the PCI bus 512 is being tasked to interconnect with a secondary PCI bus, downstream of the PCI bus 512, a bridge circuit may be provided. In the current embodiment that bridge circuit may be identified as PCI—PCI bridge 556. An example of when this functionality may be needed is when the system 500 is a notebook computer. The notebook computer may use connector 566 to dock with and communicate with an expansion station. The expansion station may include a PCI bus as part of its hardware arrangement and connection between it and the PCI bus 512 may be enabled through the PCI—PCI bridge 556. When a secondary PCI bus is not connected downstream, the bridge 556 may be disabled by disabling the PCI bus 512 signals at the end of the PCI bus 512. The connector 566 may be enabled as a communication subsystem and while shown coupled with the PCI bus 512 it may also couple with the ISA bus 522 for allowing the system 500 to communicate with a remote information handling system.

The present embodiment shows that the PCI bus 512 is coupled with the ISA bus 522 via a PCI bus—ISA bus bridge (PCISA) 514. The PCISA 514 includes a USB route controller for connecting a USB port 516. USB devices, such as a digital camera, MP-1, tablet, mouse, and the like, may be inserted and removed from the USB port 516 while the system 500 is operating, and the hardware system 500 may provide a plug-and-play capability for reconfiguring the system configuration once a USB device has been identified. The USB router controller may further enable the operation of a peripheral USB and a general purpose bus. The PCISA 514 additionally includes an IDE (Integrated Drive Electronics) interface. This interface connects external storage devices that conform to the IDE specifications. In this manner data transfer between an IDE device 518 and the main memory 510 may occur without passing through the CPU 502. IDE device 518 may include DVD drives, HDD (hard disk drives), and the like. An IDE CD-ROM 520 is also connected with the IDE interface, preferably using an ATAPI (AT Attachment Packet Interface). The IDE device 518 and IDE CD-ROM 520 are typically located in a “media bay” of the computer. This “media bay” is usually situated for interaction by a user with its various components, which makes using the various devices easier. Other devices, which will be discussed later, may also be included within the “media bay”.

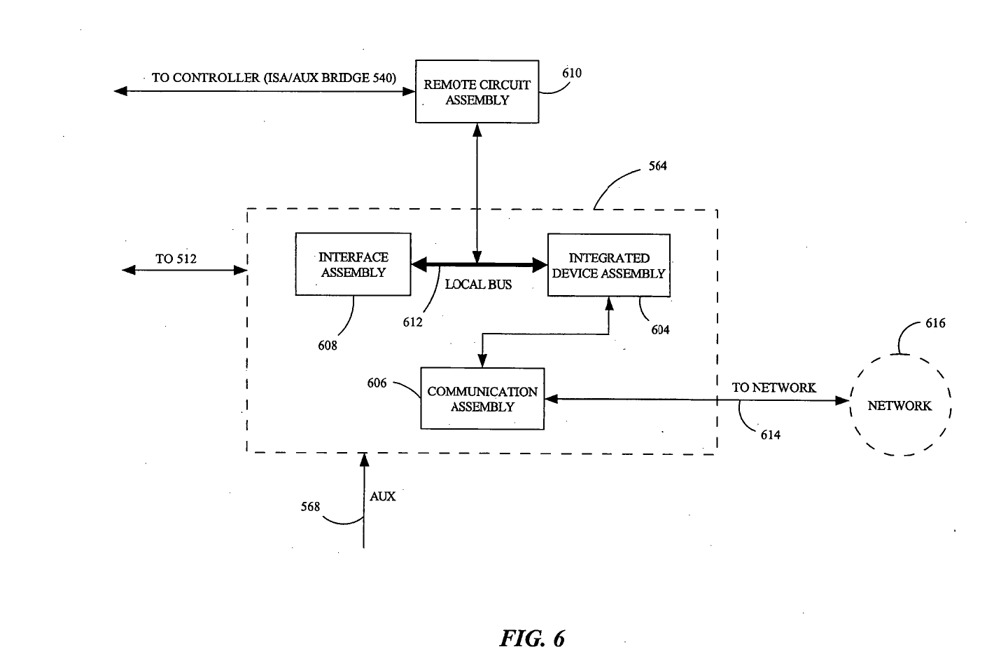

The PCI bus 512 and the ISA bus 522 are connected by the PCISA bridge 514 allowing communication between those devices coupled with the ISA bus 522 and the CPU 502, when needed. The PCISA bridge 514 includes power management circuitry which is coupled via AUX II with a power adapter 562 that brings power in from a power supply to the system 500. The power management circuitry allows the hardware system 500 to change between various power states, such as normal operating state, off, suspend, and the like. Enough power is supplied to the hardware system 500 so that when it is in the off or suspend state, the hardware system 500 may monitor for events which cause the system 500 to be re-enabled. In the present embodiment the power management circuitry is also enabled as a controller for the auxiliary bus 542 coupled through an ISA bus—AUX bus bridge 540 to the ISA bus 522. The auxiliary bus 542 is a low speed bus, and it is contemplated that the auxiliary bus 542 may be enabled as a system management (SM) bus for enabling the functioning of a LAN adapter 564 (both the SM bus and LAN adapter will be discussed below in FIG. 6). In such an instance the ISA bus—AUX bus bridge 540 may act as the controller. The power management circuitry may be further enabled as a programmable interval timer (PIT) which is configurable by a user to expire after a predetermined period of time. For example, when the timer expires, the hardware system 500 will change from the off state to the normal operating state. It is further contemplated that the PCISA bridge 514 may include a DMA controller and a programmable interrupt controller (PIC). The DMA controller may be used for performing a data transfer between a peripheral device and the main memory 510 that the data does not pass through the CPU 502. The PIC may execute a program (an interrupt handler) in response to an interrupt request from a peripheral device to which it is coupled.

The ISA bus 522 connects with an auxiliary memory 524, ROM 526, auxiliary processors 528, a CMOS/RTC 538 (CMOS=Complementary Metal Oxide Semiconductor), an I/O controller 530, the ISA bus—AUX bus bridge 540, a keyboard/mouse controller 544, and an analog switch 558. Typically, the ISA bus 522 transfers data at a lower speed than the PCI bus 512. The auxiliary memory 524 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 524 may also include a variety of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well. The auxiliary memory 524 may provide a variety of functionalities to the hardware system 500, such as the storage of instructions and data that are loaded into the main memory 510 before execution. In this way, the auxiliary memory 524 acts in a very similar manner to the ROM 526, described below.

The ROM 526 is a non-volatile memory for the permanent storage of a code group, such as a BIOS (Basic Input/Output System) or the like having input and output signals for hardware components, such as a floppy disk drive (FDD) 532, a keyboard 546, and a mouse 548. Additionally the ROM provides for the permanent storage of firmware, such as a test program like a POST (Power on Self Test) or the like that is run when the hardware system 500 is first powered on. It is understood that the hardware system 500 may include both the auxiliary memory 524 and the ROM 526 or be enabled with only one of these memory devices without departing from the scope and spirit of the present invention.

The hardware system 500 includes an auxiliary processing system 528 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that the system 500 may employ such auxiliary processors as discrete processors; processors built in to the main processor, or may not include such processors at all.

The CMOS/RTC 538 is a chip which includes an RTC (real time clock) which is used for time of day calculations and the CMOS memory. The CMOS memory is typically used to store information, such as BIOS setup values, passwords, and vital parts of a system configuration.

The I/O controller 530 provides interface functionality between the one or more I/O devices 532-536 and the ISA bus 522. I/O devices include FDD 532, Parallel Port 532, and a Serial Port 536, in the present embodiment. It is contemplated that the I/O controller 512 may interface with the universal serial bus (USB) port 516, an IEEE 1394 serial bus port, infrared port, network adapter, printer adapter, radio-frequency (RF) communications adapter, universal asynchronous receiver-transmitter (UART) port, and the like. Further, it is contemplated that the I/O controller 530 may provide for the interfacing between corresponding I/O devices such as the keyboard 546, the mouse 548, trackball, touchpad, joystick, trackstick, infrared transducers, printer, modem, RF modem, bar code reader, charge-coupled device (CCD) reader, scanner, compact disc (CD) drive, compact disc read-only memory (CD-ROM) drive 520, digital versatile disc (DVD) drive, video capture device, TV tuner card, touch screen, stylus, electro acoustic transducer, microphone, speaker, audio amplifier, and the like. The I/O controller 530 and I/O devices 532-536 may provide or receive analog or digital signals for communication between the hardware system 500 of the present invention and external devices, networks, or information sources. The I/O controller 530 and I/O devices 532-536 preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It may be appreciated that modification or reconfiguration of the hardware system 500 of FIG. 5 by one having ordinary skill in the art would not depart from the scope or the spirit of the present invention.

In the preferred embodiment, the keyboard/mouse controller 544 is enabled for fetching input provided through use of the keyboard 546 and/or the mouse 548. In an alternative embodiment, it is contemplated that the functionality performed by the keyboard/mouse controller 544 may reside in the I/O controller 530. Other controllers, such as an audio signal controller for processing the input/output of audio signals may be included within the hardware system 500. An analog switch 558 couples the ISA bus 522 with the connector 566. The analog switch 558, responding to whether or not a secondary PCI bus is connected with the hardware system 500, weakens the signal at the end of the ISA bus 522 and disconnects the ISA bus 522 from the connector 566.

A power adapter 562 for transforming an external AC power source into a DC voltage is coupled with a DC/DC converter 560. The DC/DC converter 560 provides a stable DC voltage to the components of the hardware system 500. It is contemplated that power may be received via the connector 566 by the DC/DC converter 560 and then reduced and stabilized for use by the hardware system 500. In this case, the power is carried along a power feed line 572 to the DC/DC converter 560. The PCISA bridge 514 is supplied with auxiliary power via a power feed line 570 from the DC/DC converter 560. A LAN adapter 564 (described below in FIG. 6) receives auxiliary power via a power feed line 568 from the DC/DC converter 560. This auxiliary power source may be required when the system 500 is enabled in an “off” state. For example, when the hardware system 500 is “off” the PCISA bridge 514 may need to monitor the hardware system 100 for events which may cause the hardware system 500 to be re-enabled. In the LAN adapter 564, auxiliary power may be required for scanning all inputs received from the LAN. The LAN adapter 564 may scan for a particular data frame coupled with the input from the LAN and, if the data frame is not found refuse the input. If the data frame is found, the LAN adapter 564 may alert (i.e., WOL) the PCISA bridge 514, including the power management circuitry, to power the hardware system 500 to a normal operating state.

While the hardware system 500 has been referenced and will continue to be referenced during description of the present invention, it is understood that the configuration of the hardware system 500 may be varied, as contemplated by one of ordinary skill in the art, without departing from the scope and spirit of the present invention. For example, the type of CPU/Processor used may vary and the type and number of controllers, busses, and devices connected to the CPU/Processor may also vary.

An exemplary embodiment of the present invention is shown in FIG. 6. The LAN adapter 564 comprises an integrated device assembly 604 communicatively coupled with a communication assembly 606 and an interface assembly 608. The integrated device assembly 604 is communicatively coupled with the interface assembly 608 via local bus 612. The communication assembly 606 is further coupled with a cable 614 which establishes a communicative link with a network 616. It is understood that the LAN adapter 564 may provide the communicative link between the computer 500 and the network 616 directly or it may provide the interface for the LAN card as described above in FIG. 1.

In the preferred embodiment, the integrated device assembly 604 is a chip which provides for the transmission of data between the computer 500 and the network 616. The chip may maximize its link with the computer 500 through interface assembly 608 by determining what connection technology the chip has in common with the computer 500 and then utilizing that connection technology which enables the highest performance. The chip may also function to transmit its capabilities to the computer 500 and determine the capabilities of computer 500. The chip is the physical layer of the LAN adapter 564 and may support a variety of applications, such as Ethernet applications and the like. In operation, the chip may receive parallel data from the local bus 612 (description of the local bus 612 below) and convert it to serial data for transmission through the communication assembly 606 over cable 614 to the network 616.

In the current embodiment, the integrated device assembly 604, or chip, may further include a memory for the storage of information received, such as the special Wake-on-LAN data packet of the present invention. Thus, the chip may provide the information regarding the parameters of the pre-determined operating environment the computer 500 is to be awakened to. This functionality is enabled by an auxiliary power source being provided to the LAN adapter 564 which allows the LAN adapter 564 to operate regardless of the power state the computer 500 is in (i.e., normal operation, sleep, suspend, standby, off, and the like). In the current embodiment, the auxiliary power is provided via the DC/DC converter 560 from the power adapter 562, which connects the computer 500 with an external AC power source. Therefore, as long as the connection with the AC power source is maintained, auxiliary power is available. It is contemplated that auxiliary power may be provided from alternative computer 500 power sources, such as a battery and the like. The LAN adapter 564 is able to send and receive data packets while operating under auxiliary power, thereby supporting operation of the special Wake-on-LAN packet of the present invention.

The communication assembly 606 is the physical interface between the cable 614 and the LAN adapter 564. The communication assembly 606 may be a variety of network connectors as contemplated by one of ordinary skill in the art.

The interface assembly 608 provides the physical interface between the LAN adapter 564 and the rest of the computer 500; in particular the interface assembly 608 establishes a link with the PCI bus 512. Through this link the transmission of data, as described above, occurs between the computer 500 and the network 616. The interface assembly 608 is coupled with the local bus 612. The local bus 612 links the interface assembly 608 with the integrated device assembly 604 (underlying physical layer). It is contemplated that the local bus 612, in one embodiment, may be a media independent interface which provides the protocols and signals needed to link the interface assembly 608 with the integrated device assembly 604. In operation, the interface assembly 608 may encode/decode signals (e.g., digital signals) transmitted over the local bus 612, enabling bit transmission/reception and various other tasks as contemplated by one of ordinary skill. For example, during reception of a data packet, the interface assembly 608 may perform address checks and error detections as it disassembles the data packet. If, as described above, the integrated device assembly 604 includes a memory location in which the received data packets are to be stored, the interface assembly 608 may provide for the routing of the data to the memory location. During a transmission of data, from the computer 500 to the network 616, the interface assembly 608 may again perform address checks and error detection as it assembles the data for transmission. It is contemplated that the interface assembly 608 may be a media access controller (MAC) or similar device, which facilitates the transmission of data over a shared data path (local bus 612) within the LAN adapter 564.

Thus, the methods of the present invention may be executed through the LAN adapter 564. For example, the special Wake-on-LAN packet, containing instructions for configuring a computer into a pre-determined operating environment, may be running on a remote computer connected to the network. The remote computer may issue the special Wake-on-LAN packet over the network to the exemplary computer 500 of the present invention. The LAN adapter 564 of the computer 500 receives the special Wake-on-LAN packet and may store the pre-determined operating environment. As described above, the storage may occur in the memory location of the integrated device assembly 604. Then the BIOS of the computer 500 may access the pre-determined operating environment instructions in the memory during a boot sequence.

In FIG. 6 a remote circuit 610 is shown coupling with the LAN adapter 564 through the local bus 612. The coupling of the remote circuit 610 with the LAN adapter 564 may be through other buses as contemplated by one of ordinary skill. In the preferred embodiment, the remote circuit 610 performs several functions. When the computer 500 is in a sleep mode, the remote circuit 610 is responsible for receiving and decoding packets sent to the computer 500. When the computer 500 is on (normal operating conditions), the data packets are handled by the interface assembly 608 and sent to the operating system. In the preferred embodiment, the ISA/AUX bridge 542 acts as the controller for remote circuit 610 through auxiliary bus 542. In an alternative embodiment, the remote circuit 610 may be controlled through the PCI/ISA bridge 514 via the PCI bus 512. It is understood that the remote circuit 610 may support an interface with various controllers located within the computer 500 without departing from the scope and spirit of the present invention. The remote circuit 610 may contain registers or other storage devices which store the desired pre-determined operating environment provided by the special Wake-on-LAN packet. Thus, when the computer 500 is in sleep mode, the remote circuit 610 receives and decodes the data packets and then stores them. The registers may then be accessed by the BIOS during the boot sequence of the computer 500 and provide the instructions which enable the BIOS to load the appropriate predetermined operating environment into the computer 500.

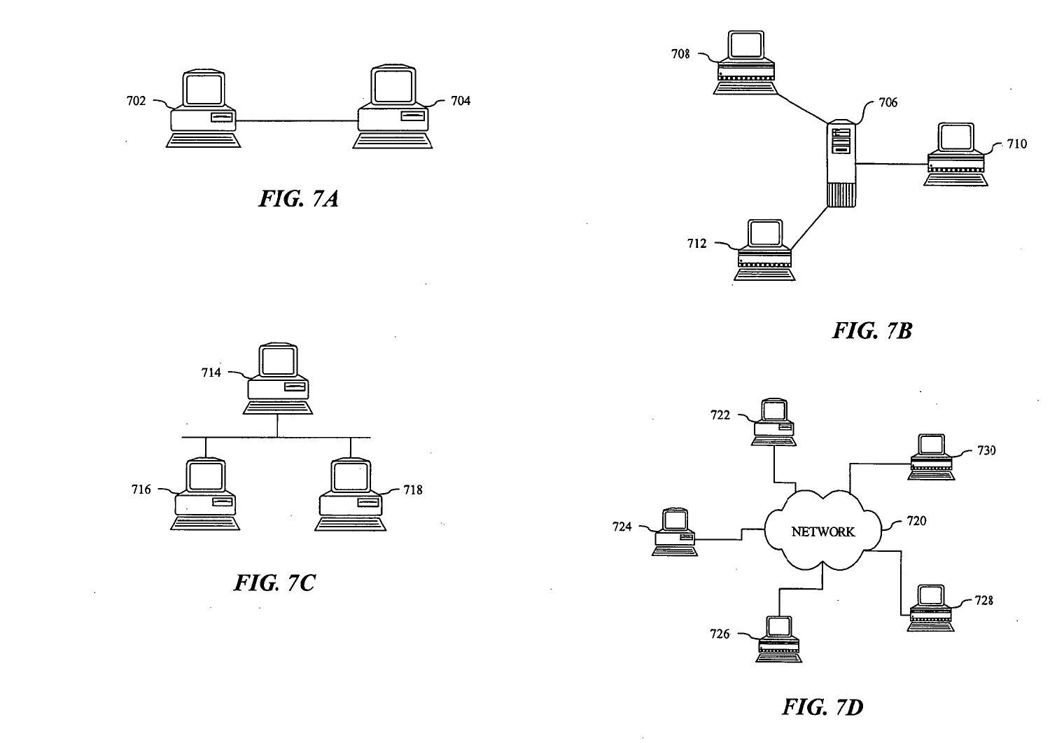

FIGS. 7A through 7D provide exemplary embodiments of network systems over which the present invention may be employed utilizing computer systems configured as described above in FIG. 5 and 6. It is understood that the terms computer, remote computer, and personal computer may be used interchangeably for identifying the computers coupled with the network. In a first embodiment, a first computer 702 is coupled with a second computer 704. The first computer 702 may be the initiator which contains an application, which may be a software LAN application or the like, including the special Wake-on-LAN packet of the present invention. The first computer 702 may transmit this LAN application to the second computer (slave computer) 704 which may or may not be in a sleep mode. The slave computer will then boot into the pre-determined operating environment instructed by the LAN application. In the second embodiment, shown in FIG. 7B, a server 706 is coupled with a first personal computer 708, a second personal computer 710 and a third personal computer 712. The server 706 may be configured with an exemplary hardware system similar, in most respects, to that shown and described in FIG. 5. The first, second, and third personal computers may be similar to the hardware configuration of FIG. 5. In this instance, the server 706 is a managing computer controlling the function of the personal computers and will contain and transmit the special Wake-on-LAN packet. FIG. 7C shows a network including a first computer 714 coupled to a second computer 716 and a third computer 718. With each computer coupled to one another, the special Wake-on-LAN packet may be stored in any one of the computers and then transmitted to the other computers. A network 720 is shown connecting a first remote computer 722, a second remote computer 724, a third remote computer 726, a fourth remote computer 728, and a fifth remote computer 730. In this embodiment, a special Wake-on-LAN packet may be transmitted over the network to each of the remote computers. It is understood that the special Wake-on-LAN packet each computer, remote computer, personal computer, or the like, receives may provide instructions for the loading of a unique pre-determined operating environment as compared to that received by the other computers, remote computers, and personal computers. It is further contemplated that server computers may be coupled to a network and receive a special Wake-on-LAN packet directing the loading of a pre-determined operating environment.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method may be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method of operating a computer in a networked computing environment, comprising:
communicating a wake up state to the computer; and
awakening the computer to the wake up state, the wake up state being one of a plurality of states in which the computer is configured to operate,
wherein the wake up state enables operation of a task or storage by the computer.

2. The method of claim 1, wherein an initiator communicates the wake up state to the computer.

3. The method of claim 1, wherein the computer receives the wake up state via a communication assembly.

4. The method of claim 3, wherein the communication assembly is a LAN card.

5. The method of claim 1, wherein the wake up state is specified by a special Wake-on-LAN (WOL) packet.

6. The method of claim 1, wherein the networked computing environment is a wireless network computing environment.

7. The method of claim 1, wherein the networked computing environment is a grid computing environment.

8. The method of claim 1, wherein the wake up state defines a pre-determined operating environment to be loaded into the computer which controls the activation of hardware subsystems on the computer, execution of applications by the computer, and establishes communication with the initiator of the wake up state.

9. The method of claim 1, further comprising the step of executing a function by the computer.

10. The method of claim 1, further comprising the step of returning the computer to a sleep state after the computer has executed the function.

11. A method of operating a computer in a networked computing environment, comprising:
placing the computer in a sleep state;
communicating a wake up state to the computer from an initiator; and
awakening the computer into the wake up state, the wake up state being one of a plurality of states in which said computer is configured to operate,
wherein the wake up state enables operation of a task or storage by the computer.

12. The method of claim 11, wherein an initiator communicates the wake up state to the computer.

13. The method of claim 11, wherein the computer receives the wake up state via a communication assembly.

14. The method of claim 13, wherein the communication assembly is a LAN card.

15. The method of claim 11, wherein the wake up state is specified by a special Wake-on-LAN (WOL) packet.

16. The method of claim 11, wherein the networked computing environment is a wireless network computing environment.

17. The method of claim 11, wherein the networked computing environment is a grid computing environment.

18. The method of claim 11, wherein the wake up state defines a pre-determined operating environment to be loaded into the computer which controls the activation of hardware subsystems on the computer, execution of applications by the computer, and establishes communication with the initiator of the wake up state.

19. The method of claim 11, further comprising the step of executing a function by the computer.

20. The method of claim 11, further comprising the step of returning the computer to a sleep state after the computer has executed the function.

21. A signal tangibly embodying a set of computer readable instructions, comprising:
a first command communicating a wake up state from a managing computer to a slave computer; and
a second command for communicating a function to be executed by the slave computer during the wake period,
wherein the signal initiates a loading of a pre-determined operating system into the slave computer for performance of the function.

22. The signal of claim 21, further comprising a third command for returning the slave computer to a sleep state upon completion of the function.

23. The signal of claim 21, wherein the communicating of the wake up state to the slave computer is enabled by a LAN card.

24. The signal of claim 21, wherein the wake up state is specified by a special Wake-on-LAN (WOL) packet.

25. The signal of claim 21, wherein the networked computing environment is a wireless network computing environment.

26. The signal of claim 21, wherein the networked computing environment is a grid computing environment.

27. The signal of claim 21, wherein the networked computing environment is selected from the group consisting of a LAN, a WAN, the Internet, an internet, or an intranet.

28. The signal of claim 21, wherein the pre-determined operating environment controls the activation of hardware subsystems, execution of applications on the computer, and establishes communication with the initiator of the wake up state.

29. The signal of claim 21, wherein the pre-determined operating environment is an operating system that determines activation of hardware subsystems and execution of applications and establishes communication with the initiator of the wake up state.

30. The signal of claim 21, wherein the task is selected from the group consisting of accept new tasks, transfer files, or load files.

31. A method for performing a task in a networked computing environment, comprising:
communicating a wake up state from a managing computer to a slave computer that is currently in a sleep mode;
establishing a pre-determined operating environment on the slave computer, the pre-determined operating environment being one of a plurality of states the slave computer is configured to operate in;
executing a task on the slave computer utilizing the functionality provided by the pre-determined operating environment; and
returning the slave computer to the sleep mode,

32. The method of claim 31, wherein the communicating of the wake up state to the computer is enabled by a network card.

33. The method of claim 31, wherein the wake up state is specified by a special Wake-on-LAN (WOL) packet.

34. The method of claim 31, wherein the networked computing environment is a wireless network computing environment.

35. The method of claim 31, wherein the networked computing environment is a grid computing environment.

36. The method of claim 31, wherein the networked computing environment is selected from the group consisting of a LAN, a WAN, the Internet, an internet, or an intranet.

37. The method of claim 31, wherein the pre-determined operating environment controls the activation of hardware subsystems, execution of applications on the computer, and establishes communication with the initiator of the wake up state.

38. The method of claim 31, wherein the pre-determined operating environment is an operating system that determines activation of hardware subsystems and execution of applications and establishes communication with the initiator of the wake up state.

39. The method of claim 31, wherein the task is selected from the group consisting of accept new tasks, transfer files, or load files.

40. An apparatus for connecting a computer to a network and providing a signal to the computer for instructing the computer to load a pre-determined operating environment onto the computer, comprising
a communication assembly communicatively coupling the apparatus with the network, the communication assembly for receiving a special Wake-on-LAN (WOL) packet specifying a wake up state to the computer from an initiator communicatively coupled to the network;
an integrated device assembly coupled with the receiver assembly, the integrated device assembly for supporting the receipt and transmission of the wake up state to the computer;
an interface assembly coupled with the integrated device assembly, the interface assembly for providing a communicative coupling between the integrated device assembly and the computer; and
a local bus assembly coupled with the integrated device assembly, the local bus providing the interface between the interface assembly and the integrated device and between the integrated device assembly and a remote circuit assembly,
wherein the apparatus awakens the computer to the wake up state, the wake up state being one of a plurality of states in which the computer is configured to operate.

41. The apparatus of claim 40, wherein the remote circuit assembly provides the support for the receipt and transmission of the special Wake-on-LAN (WOL) packet.

42. The apparatus of claim 40, wherein the special Wake-on-LAN (WOL) packet specifies a pre-determined operating environment.

43. The apparatus of claim 42, wherein the pre-determined operating environment controls the activation of hardware subsystems, execution of applications on the computer, and establishes communication with the initiator of the wake up state.

44. The apparatus of claim 42, wherein the pre-determined operating environment is an operating system that determines activation of hardware subsystems and execution of applications and establishes communication with the initiator of the wake up state.

45. The apparatus of claim 40, wherein the apparatus is a network adapter operationally disposed within the computer.

46. The apparatus of claim 45, wherein the network adapter is a network card.

47. The apparatus of claim 45, wherein the network adapter is a LAN card.

48. The apparatus of claim 40, wherein the integrated device is an integrated circuits system.

49. The apparatus of claim 40, wherein the remote circuit assembly is integrated within the apparatus.

50. The apparatus of claim 40, wherein the communication assembly provides a wireless communicative coupling with the network.

51. The apparatus of claim 40, wherein the network is a grid computing network.

52. The apparatus of claim 40, wherein the network is selected from the group consisting of a LAN, a WAN, the Internet, an internet, or an intranet.

53. A computer communicatively coupled with a second computer, the computer for transmitting a signal indicating a pre-determined operating environment over a network to the second computer, comprising:
an executable stored in a memory of the computer, the executable for providing a wake up state configuration for the second computer;
a communication assembly operationally coupled with the memory, the communication assembly communicatively coupling the computer with the network for transmitting the executable,
wherein the second computer is awakened into the wake up state, the wake up state being one of a plurality of states in which the second computer is configured to operate.

54. The computer of claim 53, wherein the wake up state is specified by a special Wake-on-LAN (WOL) packet stored in the memory of the computer.

55. The computer of claim 54, wherein the special Wake-on-LAN (WOL) packet specifies the pre-determined operating environment.

56. The computer of claim 55, wherein the pre-determined operating environment controls the activation of hardware subsystems, execution of applications on the remote computer, and establishes communication with the computer which transmitted the wake up state.

57. The computer of claim 55, wherein the pre-determined operating environment is an operating system that determines activation of hardware subsystems and execution of applications and establishes communication with the computer which transmitted the wake up state.

58. The computer of claim 53, wherein the communication assembly is a network adapter.

59. The computer system of claim 58, wherein the network adapter is a network card.

60. The computer system of claim 58, wherein the network adapter is a LAN card.

61. The computer system of claim 53, wherein the communication assembly establishes a wireless communicative coupling with the network.

62. The computer system of claim 53, wherein the network is a grid computing network.

63. The computer system of claim 53, wherein the network is selected from the group consisting of a LAN, a WAN, the Internet, an internet, or an intranet.

64. A computer system which may be configured into a pre-determined operating environment by receiving a signal over a network from a remote computer, comprising:
a communication assembly for receiving the signal, which provides a wake up state and is transmitted over the network; and
a processor coupled with the communication assembly, the processor for executing the wake up state upon the computer system,
wherein the wake up state instructs the processor to awaken the computer system into one of a plurality of operational states configurable on the computer system.

65. The computer system of claim 64, wherein the wake up state is specified by a special Wake-on-LAN (WOL) packet transmitted over the network.

66. The computer of claim 65, wherein the special Wake-on-LAN (WOL) packet specifies the pre-determined operating environment.

67. The computer of claim 66, wherein the pre-determined operating environment controls the activation of hardware subsystems, execution of applications on the computer, and establishes communication with the remote computer which transmitted the wake up state.

68. The computer of claim 66, wherein the pre-determined operating environment is an operating system that determines activation of hardware subsystems and execution of applications and establishes communication with the remote computer which transmitted the wake up state.

69. The computer system of claim 64, wherein the communication assembly is a network adapter.

70. The computer system of claim 69, wherein the network adapter is a network card.

71. The computer system of claim 69, wherein the network adapter is a LAN card.

72. The computer system of claim 64, wherein the communication assembly establishes a wireless communicative coupling with the network.

73. The computer system of claim 64, wherein the network is a grid computing network.

74. The computer system of claim 64, wherein the network is selected from the group consisting of a LAN, a WAN, the Internet, an internet, or an intranet.

75. A computer network, the network establishing communicative links amongst computers via a communication framework assembly, comprising:
a first computer including a first communication adapter which communicatively couples the first computer with the communication framework assembly of the network, the first computer further comprising an executable stored in a memory which is coupled with a processor and the first communication adapter, the executable being transmitted over the network and providing a wake up state;
a second computer including a second communication adapter which communicatively couples the second computer with the communication framework assembly of the network, the second communication adapter for receiving the wake up state provided by the executable transmitted over the network,
wherein the executable transmitted over the network awakens the second computer to the wake up state, the wake up state being one of a plurality of states in which the second computer is configured to operate.

76. The computer network of claim 75, wherein the wake up state is specified by a special Wake-on-LAN (WOL) packet stored in the memory of the first computer.

77. The computer network o f claim 76, wherein the special Wake-on-LAN (WOL) packet specifies a pre-determined operating environment on the second computer.

78. The computer of claim 77, wherein the pre-determined operating environment controls the activation of hardware subsystems, execution of applications on the second computer, and establishes communication with the first computer which transmitted the wake up state.

79. The computer of claim 77, wherein the pre-determined operating environment is an operating system that determines activation of hardware subsystems and execution of applications on the second computer and establishes communication with the first computer which transmitted the wake up state.

80. The computer network of claim 75, wherein at least one of the first and second communication adapters is a network adapter operationally disposed within the first and second computers, respectively.

81. The computer network of claim 80, wherein at least one of the first and second network adapters is a network card.

82. The computer network of claim 80, wherein at least one of the first and second network adapters is a LAN card.

83. The computer network of claim 75, wherein the computer network is a wireless computer network.

84. The computer network of claim 75, wherein the network is a grid computing network.

85. The computer network of claim 75, wherein the network is selected from the group consisting of a LAN, a WAN, the Internet, an internet, or an intranet.

86. A computer system, comprising:
means for communicating between at least two computers; and
means for establishing one of the at least two computers into a pre-determined operating environment specified by a signal sent form another of the at least two computers via the means for communication.

87. The computer system of claim 86, wherein the communication means is a network.

88. The computer system of claim 86, wherein the means for establishing one of the at least two computers into a pre-determined operating environment is by transmission of a special Wake-on-LAN (WOL) packet over the communication means from a first computer to a second computer.
